(19) United States
(12) Patent Application Publication
(10) Pub. No.: US 2022/0128029 A1
(43) Pub. Date: Apr. 28, 2022

(54) IMPROVING OR OPTIMIZING WIND TURBINE OUTPUT BY DETECTING FLOW DETACHMENT

(71) Applicant: POLYTECH WIND POWER TECHNOLOGY GERMANY GMBH, Munchen (DE)

(72) Inventors: Onur KIMILLI, Munchen (DE); Markus SCHMID, Munchen (DE); Luis VERA-TUDELA, Munchen (DE)

(21) Appl. No.: 17/291,425

(22) PCT Filed: Nov. 7, 2019
(86) PCT No.: PCT/EP2019/080571

§ 371 Date: May 5, 2021

(30) Foreign Application Priority Data
Nov. 7, 2018 (DE) 10 2018 127 804.7

(51) Int. Cl. F03D 7/02; F03D 7/04; F03D 17/00

(52) U.S. Cl. CPC F03D 7/0296; F03D 7/02; F03D 7/04; F05B 2270/333; F05B 2220/30; F05B 2270/301; F03D 17/00

(57) ABSTRACT

A method for controlling a wind power plant is described. The method comprises measuring a sound emission by means of at least one pressure sensor secured to the rotor blade; detecting a characteristic aeroacoustic sound for at least one stall based on the sound emission; and controlling or regulating one or several components of the wind power plant based on the detection of the characteristic aeroacoustic sound of the stall.

### TECHNICAL FIELD

In general, the present invention relates to the control or regulation of wind power plants, in particular to a measurement for improving the yield of wind power plants. In particular, embodiments relate to measurements for the improved operation of rotor blades with a relatively large thickness, for example with respect to a stall. In particular, the invention relates to a method for controlling a wind power plant and to a wind power plant.

### TECHNICAL BACKGROUND

Wind power plants have an increasingly large rotor diameter. In particular during their construction, this brings major challenges with respect to the structural stability. In order to also be able to withstand extreme wind conditions, it is advantageous for rotor blades to have a specific stiffness.

One possibility that helps to provide the stiffness involves increasing the material thickness of rotor blades. However, this leads to an elevated weight of the rotor blades and rising costs for wind power plants. Another possibility lies in increasing the thickness of the rotor blade profile. This makes it possible to likewise increase the stiffness, while in so doing not unnecessarily increasing the material usage. This results in less expensive rotor blades.

The profile thickness can be increased by increasing the profile depth while maintaining the relative profile thickness. The profile depth is the distance between the leading edge and trailing edge of the profile. The profile thickness can further be increased by using thicker profiles for a rotor blade, i.e., by increasing the relative thickness. In general, the profile thickness is limited by the loads on the rotor blade. In general, increasing the profile depth results in higher fatigue loads. The profile depth can further be limited for reasons of transporting a wind power plant. In addition, it is not desirable to increase the profile depth above specific limits, since it can lead to buckling problems.

Based on the limitations on profile depth, the tendency is to increase the absolute profile thickness of rotor blades. Even though this is structurally advantageous, it results in aerodynamic disadvantages. For example, the profiles are sensitive with respect to surface roughness, differences in yield between clean rotor blades and dirty rotor blades increase, and the resistance of a rotor blade also increases. These aerodynamic disadvantages reduce the yield of wind power plants. Therefore, compromises are made during design and construction.

In order to counter part of the negative aerodynamic effects of thicker profiles of a wing structure, use can be made of vortex generators (or turbulators) on rotor blades of wind power plants. Vortex generators are used to reduce or minimize the differences in performance between clean and dirty wing structures, and prevent a stall by increasing the stall angle. However, vortex generators produce a high air resistance. Therefore, the lift-to-air resistance ratio of the airfoils is reduced. As a result, the yield of a wind power plant is reduced by comparison to a clean rotor blade without vortex generators. Vortex generators typically generate a yield lying between that of a clean rotor blade without vortex generators and a dirty rotor blade without vortex generators. A plurality of compromises are typically considered during construction design.

For example, retractable vortex generators are used in aviation (e.g., see US 2007/0018056A1).

It would be desirable to further improve or optimize the yield of wind power plants.

### SUMMARY

Embodiments of the present invention provide a method for controlling a wind power plant according to claim 1, a device for controlling a wind power plant with a rotor according to claim 10, and a wind power plant according to claim 12. Additional details, embodiments, features and aspects may be gleaned from the subclaims, the specification and the drawings.

One aspect provides a method for controlling a wind power plant. The method consists of measuring a sound emission by means of at least one pressure sensor secured to the rotor blade; detecting a characteristic aeroacoustic sound for at least one stall based on the sound emission; and controlling or regulating one or several components of the wind power plant based on the detection of the characteristic aeroacoustic sound of the stall.

One aspect provides a device for controlling a wind power plant with a rotor. The device comprises at least one pressure sensor secured to a rotor blade; and an evaluation unit for detecting a characteristic aeroacoustic sound for at least one stall based on the sound emission; and controlling or regulating one or several components of the wind power plant based on the detection of the characteristic aeroacoustic sound.

Another aspect provides wind power plants with devices according to embodiments described here.

Another embodiment provides a hardware module comprising a computer program designed to implement the methods of the embodiments described here.

### BRIEF DESCRIPTION OF THE DRAWINGS

Exemplary embodiments are shown on the drawings, and explained in more detail in the following specification. The drawings show:

FIG. 1 schematically shows a rotor blade with a device or a measuring apparatus adjusted for improving the yield with respect to detecting a stall on a wind power plant according to the embodiments described herein;

FIG. 2 shows a wind power plant according to embodiments described herein;

FIG. 3 schematically shows an embodiment of a fiberoptic pressure sensor with a cavity, in a longitudinal section along a fiber optic axis;

FIG. 4A schematically shows an embodiment of a fiberoptic pressure sensor with an optical resonator;

FIG. 4B shows an embodiment of the fiberoptic pressure sensor depicted on FIG. 4A in a perspective view;

FIG. 5 schematically shows a measurement setup for a fiberoptic pressure sensor according to embodiments described here;

FIG. 6 schematically shows a measurement setup for a fiberoptic pressure sensor according to embodiments described here;

FIG. 7 shows a flowchart of a method for controlling or regulating a wind power plant according to embodiments of the invention.

Identical reference numbers on the drawings denote the same or functionally equivalent components or steps.

### DETAILED DESCRIPTION OF THE EMBODIMENTS

Detailed reference is made below to various embodiments of the invention, wherein one or several examples are illustrated in the drawings.

Embodiments of the present invention relate to the measurement of airborne sound, in particular with fiberoptic pressure sensors, in a frequency band, for example a broad frequency band. The sound or noise, i.e., the measured airborne sound, can be analyzed and divided into different categories or classified. The airborne sound allocated to a stall can be used to move or change vortex generators. In particular, vortex generators can be moved or extended on an inner part of a rotor blade. Furthermore, vortex generators can be changed, so that the change makes it possible to provide an active state and a passive state. Changing a vortex generator to an active state leads to an aerodynamic effect, while a change [into] a passive state reduces or prevents the aerodynamic effect. This reduces the load on outer parts of the rotor blade, and impedes a stall or the sound of the stall. Since the full performance of the rotor blade is provided on its inner part, the yield of the wind power plant increases. For operating conditions in which the characteristic sound of a stall is not detected, the vortex generators can be moved or retracted, or changed into a passive state. Unnecessary flow resistance owing to vortex generators and disadvantages thereof can here be avoided. Furthermore, the pitch angle and/or the high-speed number (tip speed ratio, TSR) can alternatively or additionally be improved or optimized based on the detected sound of a stall, so as to improve or maximize the yield of the wind power plant.

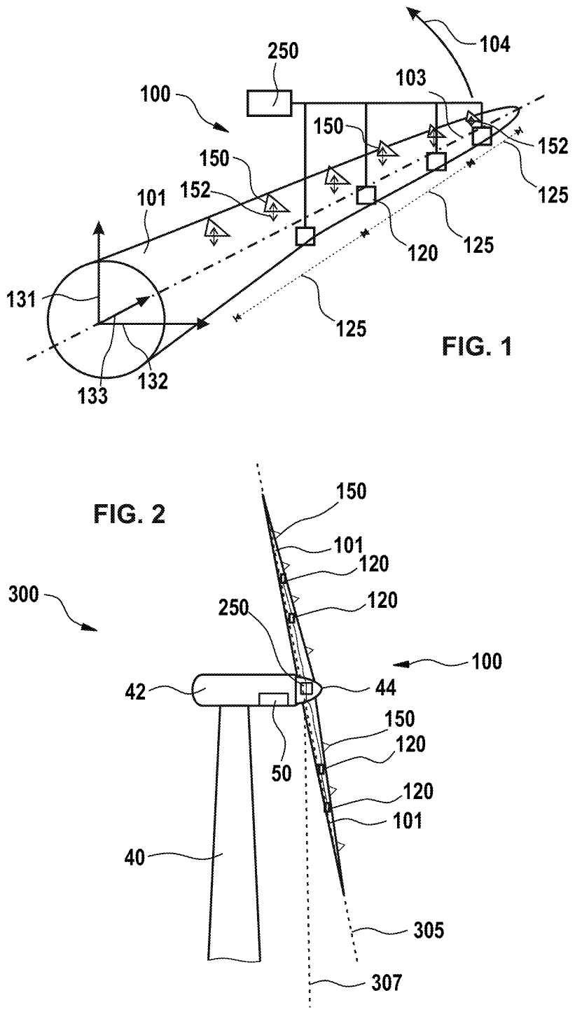

FIG. 1 shows the device 100 for controlling the wind power plant. The latter can be partially provided in a rotor blade 101. The device 100 comprises an evaluation unit 250. The evaluation unit 250 is connected with at least one first pressure sensor 120. The at least one pressure sensor 120, for example a fiberoptic pressure sensor, can be connected with the evaluation unit 250, for example via signal lines, such as electrical lines, fiberoptic lines, etc.

In several embodiments that can be combined with other embodiments, a fiberoptic pressure sensor can be provided in an area 125 along the radius of the rotor blade 101. Furthermore, additional pressure sensors can be arranged along additional, for example radially arranged, areas 125 of the rotor blade. In typical embodiments, pressure sensors 120 can be provided on the trailing edge of the rotor blade 120. The direction of movement of the rotor blade on the rotor is exemplarily shown with arrow 104.

In the embodiments described here, vortex generators 150 are provided on a rotor blade. As denoted by the arrows 152, a vortex generator can be moved with an actuator. Alternatively or additionally, the vortex generator can be changed, for example to get from a passive into an active state or from an active state into a passive state. In the present disclosure, reference is most often made to a movement of a vortex generator. Alternatively or additionally, vortex generators can vary in design according to the embodiments described here. A changeable vortex generator can assume an active or a passive state.

A vortex generator can be retracted or extended. In the retracted state, the air resistance of the vortex generator can be reduced, in particular in comparison to the extended state. For example, in some embodiments that can be combined with other embodiments described here, a vortex generator can be moved or retracted (or changed), so as to essentially be arranged levelly or flush with a surface of the rotor blade 101.

The evaluation unit 250 can analyze the airborne sound measured by means of the fiberoptic pressure sensors. A sound that can be allocated to a stall is detected. During the determination of a stall, the evaluation unit 250 can activate the actuators or an actuator for moving or changing a vortex generator. In other, alternative, or additional configurations, the evaluation unit 250 can determine one or several desired values for at least one of the parameters selected from the group consisting of: a high-speed number and a pitch angle.

On FIG. 1, the longitudinal axis 103 of the rotor blade 101 has a coordinate system aligned thereto, i.e., a fixed-blade coordinate system, which is exemplarily shown on FIG. 1 by the first axis 131 and second axis 132 described above. The third axis 133 is essentially parallel to the longitudinal axis 103. A change in the pitch angle essentially corresponds to a rotation of the rotor blade around the longitudinal axis 103.

The rotor blade 101 from FIG. 1 is equipped with the device 100. One or several pressure sensors 120 are secured in one or several areas 125. For example, pressure sensors can be provided at radially different positions, i.e., along the axis 103. Pressure sensors 120 can be spaced apart, in particular spaced apart in the direction of the longitudinal axis 103 of the rotor blade 101.

The pressure sensors can be used to acquire the emitted sound level. In particular, the sound level can be determined as a function of frequency. In particular, the sound level can be measured as a function of frequency in a broad frequency band, for example of 10 Hz to 30 kHz, in particular of 50 Hz to 500 Hz. For example, pressure sensors can be provided at a trailing edge of a rotor blade.

The sound level or the sound can be analyzed. Various causes of sound can be differentiated for a wind power plant based on characteristic properties. A corresponding evaluation can thus determine whether the measured airborne sound is to be allocated to a stall or whether the measured airborne sound has components to be allocated to a stall, for example in a case where several effects overlap. If a stall is acoustically detected, signals can be generated to control the wind power plant, to regulate the wind power plant, and/or to control movable or changeable vortex generators. For example, signals can be generated by the evaluation unit 250.

In addition to controlling movable or changeable vortex generators, desired values can be determined or defined for the high-speed number and/or pitch angle, for example. The desired values for operation are adjusted so as to increase the wind power plant yield. For example, the values of the improved operating parameters can be determined based on a lookup table, for example which contains values for optimal pitch angles and high-speed numbers for different aeroacoustic sounds. For example, such a lookup table can be provided in an evaluation unit. The evaluation unit can also be regarded as a control unit or any other kind of digital computing unit of a wind power plant. Within the framework of a lookup table, for example, an interpolation between the values provided there can be performed, so as to determine new desired values for operating parameters.

In embodiments of the present invention, the yield of a wind power plant can be improved or optimized, a stall can be avoided, and/or high loads can be avoided or reduced. Vortex generators can be used as required, for example extended or changed. In the case of operating conditions that require no vortex generators, the vortex generators can be retracted or moved to a passive state, so as to avoid unnecessary air resistance (drag).

In embodiments described here, a pressure sensor, for example a fiberoptic pressure sensor adjusted to measure a sound level is provided or mounted on a rotor blade. A fiberoptic pressure sensor can advantageously be used in wind power plants, since it requires no metallic parts. Further, the measuring principle allows an aeroacoustic measurement in a wide frequency range. The aeroacoustic measurement can take place directly on the rotor blade.

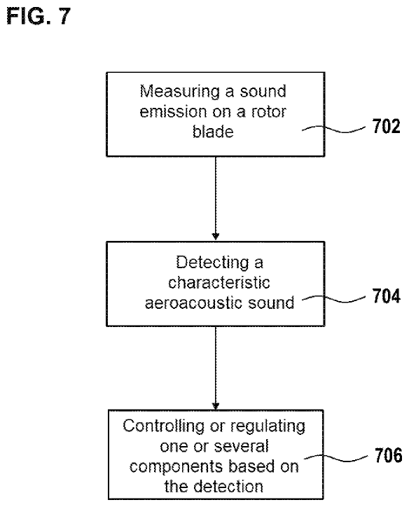

Other embodiments of the present disclosure provide a method for controlling a wind power plant. FIG. 7 depicts a corresponding flowchart. The method involves measuring a sound emission by means of a pressure sensor secured to the rotor blade, for example as illustrated by box 702. As depicted in box 704, a characteristic aeroacoustic sound for at least one stall is detected based on the sound emission. Several aeroacoustic sounds can here also be detected. For example, sounds can also be characterized for a turbulence intensity or flow input sounds. One or several components are regulated or controlled based on the detected stall, see box 706. For example, VG's can be controlled. Further, the rotor or its high-speed number or a rotor blade or its pitch angle can be controlled or regulated.

For example, a real-time determination of the characteristic aeroacoustic sounds can involve a determination at a rate of 1 Hz or faster. To this end, the sound level can be measured with a many times higher sampling rate.

FIG. 2 shows a part of a wind power plant 300. A gondola 42 is arranged on a tower 40. Rotor blades 101 are arranged on a rotor hub 44, so that the rotor (with the rotor hub and rotor blades) rotates in a plane denoted by the line 305. This plane is typically inclined relative to the perpendicular 307. Vortex generators and fiberoptic pressure sensors are provided on the rotor blades. One vortex generator is connected with an actuator, for example to provide a movable vortex generator. In an embodiment described here, an actuator can be selected from the group comprised of electric actuators, pneumatic actuators, hydraulic actuators, and combinations thereof. In particular pneumatic actuators can be logically used within the framework of a wind power plant, since a moving rotor is subjected to differences in air pressure that might potentially find application for an actuator.

The embodiments of the present invention allow vortex generators (VG's) to be activated only under specific conditions. These conditions are based on aeroacoustic sounds. The conditional activation of the VG's makes it possible to avoid unnecessary air resistance. Upon activation, the use of VG's is recommended or necessary. As a consequence, a conditional activation can improve the overall yield.

In the embodiments described here, VG's can be used in wide areas of a rotor blade, since an unnecessary rise in air resistance can be reduced or avoided. For example, VG's can be secured along the length of a rotor blade in an area of at least 50% of the blade radius. The expanded use of VG's makes it possible to improve the performance of a rotor blade. For example, VG's can be given a more robust design with respect to blade contamination, without unduly neglecting the yield within the framework of a compromise.

In embodiments of the present invention, rotor blades with thicker blade profiles can be provided, in particular on outer radial positions. Further, this takes place in combination with movable, i.e., retractable VG's. A higher stiffness can thus be provided by thicker profiles, without increasing the material thickness, wherein it might even be possible to decrease the material thickness. As a result, rotor blade costs can be reduced.

Aeroacoustic measurement with fiberoptic sensors thus enables a cost reduction owing to an enlarged profile thickness of rotor blades. Alternatively or additionally, the profile depth according to correlations described above can be reduced as needed. As a consequence, loads that lead to wear or weakening or ageing can also be reduced. The costs of a wind power plant can thus be decreased further.

Flow conditions that lead to a stall can also be detected for desired values of operating parameters for a controller or regulator. Aeroacoustic sounds can be provided locally and/or in real time or quasi-real time. For example, one or several desired values for at least one of the parameters are selected from the group comprised of a high-speed number and a pitch angle. The wind power plant is controlled or regulated based on the one or several desired values. A real-time determination, for example of a stall, can involve a determination at a rate of 1 Hz or faster. To this end, the sound level can be measured at a many times higher sampling rate. As a consequence, operating parameters such as high-speed number and pitch angle need not be decided upon assuming the most difficult conditions. The parameters or their desired values can be adjusted based on the measurement, so as to thereby improve the yield. For example, the parameters can be adjusted for the respective conditions of the rotor blade and the atmospheric conditions.

The use of fiberoptic pressure sensors with their measurement characteristics enables the use of movable VG's. VG's have thus far been rigidly secured to wind power plants, wherein the yield was adversely affected for conditions without the danger of stall. The operating point of rotor blades has thus far been selected so as to avoid a stall under extreme conditions. This happened by impairing or weighing the yield for normal operating conditions and/or times at which the blade surface is cleaner, or the flow is not disrupted.

The measurement and evaluation principles described here make it possible to improve the overall yield based on one or several of the mechanisms described here.

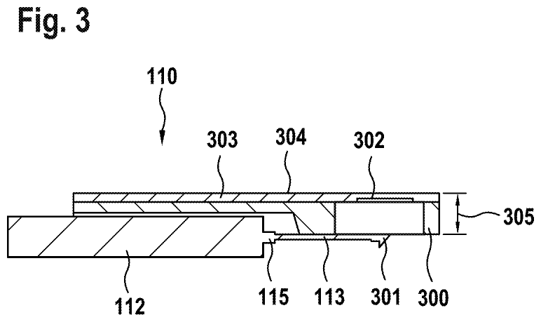

FIG. 3 schematically shows an embodiment of a fiberoptic pressure sensor 110 in a longitudinal section along a lightguide axis of a lightguide 112. A fiberoptic pressure sensor can be used to measure sound emission, so as to measure aeroacoustic sounds. Fiberoptic pressure sensors are preferred for methods used in controlling a wind power plant according to the embodiments described here, devices for controlling a wind power plant with a rotor according to embodiments described here, and wind power plants according to embodiments described here. The ability to measure without metallic lines and components is advantageous especially for reducing lightning damage.

As shown on FIG. 3, the lightguide 112 extends underneath a sensor head 300. A cavity 302 is formed in the sensor head 300, and covered by a sensor membrane 303. The sensor body 300 in its entirety is provided with a cover 304, so as to achieve an adjustable overall sensor thickness 305.

On a longitudinal position underneath the cavity 302, the outer protective jacket of the lightguide 112 is removed, so that a lightguide jacket 115 and/or a lightguide core 113 run along the lower side of the sensor head 300.

An optical deflection unit 301 is secured at one end or in proximity to the end of the lightguide 112, and serves to deflect light exiting the lightguide by about 90° in the direction toward the sensor head 300, for example by 60° to 120°, and hence toward the cavity 302. The end of the lightguide 112 here serves both as a light outlet surface for emitting light in the direction toward the optical deflection unit 301, and also as a light inlet surface for receiving light that is reflected back from the cavity 302.

The sensor body 300 exemplarily designed as a substrate is irradiated, such that light can enter into the cavity 302 and be reflected by the sensor membrane 303. The upper side and lower side of the cavity thus comprise an optical resonator, for example a Fabry-Perot resonator. The spectrum of the light reflected into the optical fiber reveals an interference spectrum, in particular interference maxima or interference minima, the position of which depends on the size of the optical resonator. Analyzing the position of the maxima or minima in the reflected spectrum makes it possible to detect a change in the resonator size or a pressure-dependent deflection of the sensor membrane 303.

In order to provide a fiberoptic pressure sensor, for example of the kind shown on FIG. 3, it is advantageous that the fiberoptic pressure sensor have a small size 305 in a cross section perpendicular to the lightguide 112 on FIG. 3. For example, a maximum size 305 in a cross section perpendicular to the axis of the lightguide 112 can measure 10 mm or less, and can in particular measure 5 mm or less. The configuration as depicted with reference to FIG. 3 makes such a dimensioning easy to realize.

In order to perform a pressure measurement, the sensor membrane 303 is exposed to the pressure to be acquired. The membrane bulges depending on the applied pressure, so that the cross sectional dimensions of the cavity 302, and hence of the optical resonator, become smaller. The pressure measurement can be used to measure sound emission, for example of the kind that arises as the result of a stall, with the pressure sensor.

In an embodiment that can be combined with other embodiments, the sensor can be used for measuring airborne sound. For example, the sensor for measuring airborne sound can be secured to the trailing edge of a rotor blade.

In another embodiment, the fiberoptic pressure sensor 110 and/or the end of the lightguide 112 have at least one optical beam shaping component, for example at the end of the lightguide core 113, so as to shape the light beam exiting the lightguide core 113, for example to widen it. The optical beam shaping component has at least one of the following: a gradient index lens (GRIN lens), a micromirror, a prism, a ball lens, and any combination thereof.

In another embodiment that can be combined with other embodiments described herein, the deflection unit 301 can be integrally designed with one of the following: a gradient index lens (GRIN lens), a micromirror, a prism, a ball lens, and any combination thereof.

Obtained in this way is a fiberoptic pressure sensor 110, which has the following: a lightguide 112 with one end, an optical deflection unit 301 connected with the end of the lightguide 112 and the sensor body 300, on which an optical resonator 302 is formed by means of the sensor membrane 303, wherein the lightguide 112 and/or the deflection unit 301 are secured to the sensor head 300 by means of a curable adhesive or a soldered connection. In an embodiment, the curable adhesive can be provided as an adhesive curable by means of UV light.

In embodiments that can be combined with other embodiments described herein, the optical resonator 302 can be designed as a Fabry-Perot interferometer, which forms a cavity with the at least one sensor membrane 303. In this way, a high resolution can be achieved while acquiring a pressure-dependent deflection of the sensor membrane 303.

In embodiments that can be combined with other embodiments described herein, the optical resonator 302 can form a cavity, which is sealed airtight relative to the environment, and has a predefined inner pressure. This provides the ability to perform a reference measurement with regard to the inner pressure. For measuring a sound pressure level, the membrane is designed to perform a movement at a corresponding sound pressure, in particular an oscillating movement, which is converted into an optical signal via the optical resonator.

In other embodiments that can be combined with embodiments described herein, the optical resonator 302 can form a cavity, which is sealed airtight relative to the environment and evacuated.

This type of fiberoptic pressure sensor 110 enables an optical pressure measurement by acquiring an optical interference spectrum output from the optical resonator and evaluating the interference spectrum to determine the pressure to be measured. During an evaluation, the phase position of the interference spectrum can be evaluated. To this end, for example, a sinusoidal interference spectrum is drawn upon for evaluation via an edge filter. In an exemplary embodiment that can be combined with other exemplary embodiments described herein, the spectrum can be selected in such a way that several periods of the interference spectrum are covered by the light source. In other words, it is typically possible to provide an interference period of 20 nm, while the light source width measures 50 nm. Due to the spectral evaluation, it might not be possible to consider the coherence length of the incident radiation here.

Fiberoptic pressure sensors make it possible to acquire aeroacoustic sounds of the wind power plant in a broad frequency range. The aeroacoustic sounds can be analyzed. Categories of sound can be determined. For example, the sound can be allocated to the trailing edge of a rotor blade, a stall, and/or an input turbulence sound. In embodiments described here, at least one characteristic can be derived from the aeroacoustic sound for a stall. Whether a stall is present or threatens to be present can be determined based on the overall sound.

The various aerodynamic sounds have individual frequency ranges and characteristics. The sound of a stall consists of a semitonal, broadband sound, with peaks at medium and low frequencies. For example, sound level peaks can arise in a range of 30 Hz to 5 kHz, in particular of 50 Hz to 500 Hz. As a result of this characterization, the sound of a stall can be detected. It is determined that a stall is arising or is starting to arise.

In embodiments described here, a signal can be output given a detection, for example by the evaluation unit 250 on FIG. 1. Vortex generators that are arranged within a rotor blade for operation without a stall, for example flat or flush with the surface of a rotor blade, can be extended. This reduces loads on the outer rotor blade areas, which prevents the stall. The stall has a semitonal characteristic to the human ear.

On FIG. 1, pressure sensors 120 and vortex generators 150 are arranged in areas 125. For example, these areas can be individually evaluated and/or the vortex generators can be individually actuated, e.g., for two or more areas along the longitudinal axis of the rotor blade. As a result, a stall divided into areas can be prevented. For example, if a stall is detected in an outer area by pressure sensors in an outer area, vortex generators in this area can be moved or activated. The full performance in an inner area is maintained. The controller or regulator can improve the overall yield of the wind power plant. If an analysis of the aerodynamic sound does not result in a stall, vortex generators can be retracted. Unnecessary air resistance is prevented.

As already described above, the detection of a stall based on the characteristic of the aeroacoustic sound can also be used for desired values of other operating parameters for a controller or regulator. For example, the operating parameters can be a high-speed number (TSR) and/or a rotor blade pitch angle. As a consequence, a stall can also be prevented by the desired values of the operating parameters.

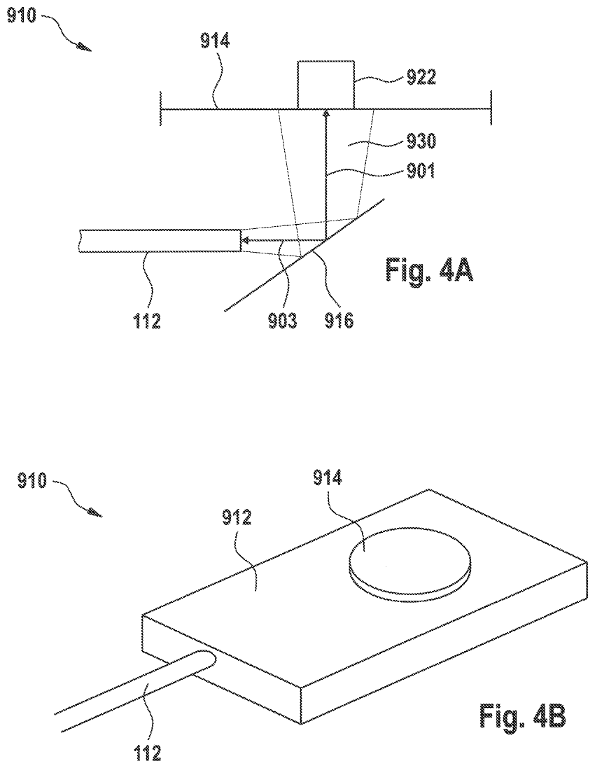

Shown schematically on FIG. 4A is a fiberoptic pressure sensor or pressure sensor 910 with an optical resonator 930. The principle of a fiberoptic pressure sensor 910 is based on an effect similar to that of the fiberoptic pressure sensor, i.e., deflecting a membrane changes the length of a resonator. In some embodiments of pressure and/or pressure sensors, as exemplarily depicted on FIG. 4A based on a pressure sensor with a mass 922, the optical resonator 930 can also be formed in an area between the outlet surface of the lightguide 112 and a reflecting surface of a membrane 914. In order to strengthen the deflection of the membrane 914 at a predefined acceleration, an added mass 922 can be secured to the membrane according to several embodiments, which can be combined with the embodiments described herein.

In embodiments that can be combined with other embodiments described herein, the fiberoptic sensor 910 can be drawn upon to measure sound and/or an acceleration in a direction roughly perpendicular to the surface of the optical resonator. The fiberoptic sensor 910 can here be made available as a pressure sensor as follows. The fiberoptic sensor 910 contains a lightguide 112 or an optical fiber with a light outlet surface. The fiberoptic sensor 910 further contains a membrane 914 and a mass 922 that is in contact with the membrane 303. The mass 922 can here either be made available in addition to the mass of the membrane, or the membrane can be provided with a suitable, sufficiently large mass. The fiberoptic pressure sensor 910 provided in this way contains an optical resonator 930, which is formed between the light outlet surface of the lightguide 112 and the membrane 914 along an extension 901, 903. For example, the resonator can be a Fabry-Perot resonator.

The fiberoptic pressure sensor 910 further contains an optical deflection unit 916, which is made available in the beam path between the light outlet surface and the membrane 914, wherein the optical deflection unit 916 can be arranged like a prism or a mirror at an angle of 30° to 60° relative to an optical axis of the lightguide or the optical fiber. For example, the mirror can be formed at an angle of 45°. As denoted by the arrow 901, the primary optical signal is deflected by the mirror 916 and directed toward the membrane 914. The primary optical signal is reflected on the membrane 914. The reflected light is coupled back into the optical fiber or lightguide 112, as illustrated by the arrow 903. As a result, the optical resonator 930 is formed between the light outlet surface for the exiting of the primary optical signal and the membrane 914. It must here be taken into consideration that the light outlet surface of the primary optical signal is generally equal to the light inlet surface for the reflected secondary signal. The optical resonator 930 can thus be designed as a Fabry-Perot resonator.

In exemplary embodiments, the components of an extrinsic fiberoptic pressure sensor 910 shown on FIGS. 4A and 4B can consist of the following materials. For example, the lightguide 112 can be a glass fiber, an optical fiber, or an optical waveguide, wherein materials such as optical polymers, polymethyl methacrylate, polycarbonate, quartz glass, ethylene-tetrafluoroethylene can be used, which are possibly doped. For example, the substrate 912 or the mirror 916 formed therein can consist of silicon. The membrane provided can consist of a plastic or a semiconductor, which is suitable to be formed as a thin membrane.

In particular given a reduction or omission of the mass 922, the membrane 914 can be used both for measuring a static pressure and for measuring a sound pressure level. In order to measure a static pressure, the area of the optical resonator 930 is separated from the ambient pressure, so that a movement of the membrane takes place given a change in the ambient pressure. For measuring a sound pressure level, the membrane is configured in such a way as to perform a movement at a corresponding sound pressure, in particular an oscillating movement, which is converted into an optical signal via the optical resonator 930.

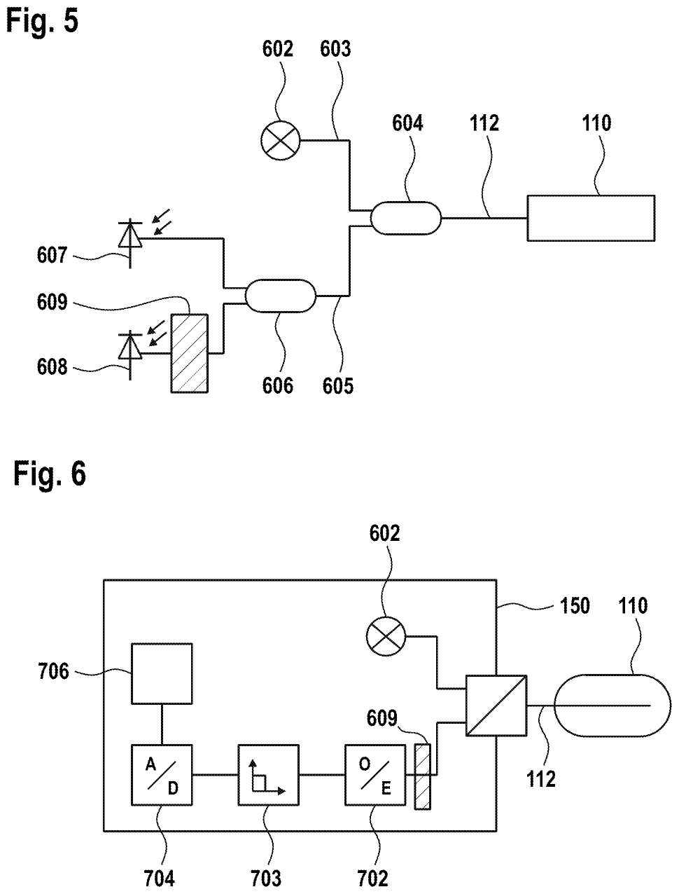

FIG. 5 shows a typical measuring system for fiberoptic pressure measurement according to the embodiments described herein. The system contains one or several pressure sensors 110. The system has a source 602 for electromagnetic radiation, for example a primary light source. The source 602 is used to provide optical radiation, with which at least one fiberoptic pressure sensor 110 can be irradiated. To this end, an optical transmission fiber or a lightguide 603 is provided between the primary light source 602 and a first fiber coupler 604. The fiber coupler 604 couples the primary light into the optical fiber or the lightguide 112. For example, the source 602 can be a broadband light source, a laser, an LED (light emitting diode), an SLD (superluminescent diode), an ASE light source (amplified spontaneous emission light source) or an SOA (semiconductor optical amplifier). Several sources of the same or differing types (see above) can also be used for embodiments described herein.

A sensor element, for example an optical resonator 302, is optically coupled to the sensor fiber 112. The light reflected by the fiberoptic pressure sensors 110 is in turn guided via the fiber coupler 604, which guides the light into a beam splitter 606 via the transmission fiber 605. The beam splitter 606 splits the reflected light for detection by means of a first detector 607 and a second detector 608. The signal detected on the second detector 608 is here initially filtered with an optical filtering device 609. The filtering device 609 can be used to detect a position of an interference maximum or minimum output by the optical resonator 302, or a wavelength change via the optical resonator.

In general, a measuring system of the kind depicted on FIG. 5 can be made available without the beam splitter 606 or the detector 607. However, the detector 607 makes it possible to standardize the measurement signal of the pressure sensor in relation to other intensity fluctuations, for example fluctuations in the intensity of the source 602, fluctuations caused by reflections at interfaces between individual lightguides, fluctuations caused by reflections at interfaces between the lightguide 112 and the deflection unit 301, fluctuations caused by reflections at interfaces between the deflection unit 301 and the optical resonator 302 or other intensity fluctuations. This standardization improves the measuring accuracy, and during operation of the measuring system reduces a dependence on the length of the lightguides 112 made available between the evaluation unit 150 and the fiberoptic pressure sensor 110.

The optical filtering device 609 or additional optical filtering devices for filtering the interference spectrum or for detecting interference maxima and minima can contain an optical filter, which is selected from the group comprised of an edge filter, a thin-film filter, a fiber Bragg grating, an LPG, an arrayed-waveguide-grating (AWG), an Echelle grating, a grating arrangement, a prism, an interferometer, and any combination thereof.

FIG. 6 shows an evaluation unit 150, wherein a signal of a fiberoptic pressure sensor 110 is guided to the evaluation unit 150 via a lightguide 112. FIG. 6 further shows a light source 602, which can optionally be made available in the evaluation unit. However, the light source 602 can also be made available independently or outside of the evaluation unit 150. The optical signal of the fiberoptic pressure sensor 110, i.e., the optical interference signal, which can have interference maxima and interference minima, is converted into an electrical signal with a detector, i.e., with an optoelectrical converter 702. The electrical signal is filtered with an analog anti-aliasing filter 703. After analog filtering with the analog-aliasing filter or low-pass filter 703, the signal is digitized by an analog-to-digital converter 704.

In several of the embodiments described here, which can be combined with other embodiments, the evaluation unit 150 can be configured in such a way that it analyzes the interference signal not only with respect to the position of interference maxima and interference minima, but rather that a determination of the phase position of the interference signal further takes place. FIG. 6 further shows a digital evaluation unit 706, for example which can contain a CPU, memory, and other elements for digital data processing.

As explained in reference to FIG. 6, a method for acquiring the pressure by means of a fiberoptic pressure sensor can be improved. For example, an evaluation unit 150 is made available. The evaluation unit 150 can contain a converter for converting the optical signal into an electrical signal. For example, a photodiode, a photomultiplier (PM) or another optoelectronic detector can be used as the converter. The evaluation unit 150 further contains an anti-aliasing filter 703, for example which is connected with the output of the converter or the optoelectronic detector. The evaluation unit 150 can further contain an analog-to-digital converter 704, which is connected with the output of the anti-aliasing filter 703. In addition, the evaluation unit 150 can contain a digital evaluation unit 706, which is set up to evaluate the digitized signals.

In still other embodiments that can be combined with embodiments described here, a temperature compensation can be provided in the fiberoptic pressure sensor 110 in such a way that materials with a very low thermal expansion coefficient are used for the sensor body 300 and/or the sensor membrane 303 and/or the cover 304.

In embodiments, the lightguide 112 can be a glass fiber, an optical fiber, or a polymer conductor, for example, wherein materials such as optical polymers, polymethyl methacrylate, polycarbonate, quartz glass, ethylene-tetrafluoroethylene can be used, which are possibly doped. In particular, the optical fiber can be designed as a single mode fiber, for example an SMF-28 fiber. The term “SMF-fiber” here denotes a special type of a standard single mode fiber.

Further proposed is a computer program product, which can be loaded directly into a memory, for example a digital memory of a digital computing device. In addition to one or several memories, a computing device can contain a CPU, signal inputs and signal outputs, as well as other elements typical for a computing device. A computing device can be part of an evaluation unit, or the evaluation unit can be part of a computing device. A computer program product can comprise software code sections with which the steps in the methods of the embodiments described here are at least partially implemented with the computer program product running on the computing device. Any embodiments of the method can here be implanted by a computer program product.

Even though the present invention was described above based on typical exemplary embodiments, it is not confined thereto, but can rather be modified in a variety of ways. The invention is also not confined to the mentioned possible applications.

1. A method for controlling a wind power plant, comprising:
measuring a sound emission by means of at least one pressure sensor secured to the rotor blade;
detecting a characteristic aeroacoustic sound for at least one stall based on the sound emission; and
controlling or regulating one or several components of the wind power plant based on the detection of the characteristic aeroacoustic sound of the stall.

2. The method according to claim 1, wherein the one or several components are a changeable or movable vortex generator.

3. The method according to claim 2, wherein the vortex generator can be moved or changed between an active and a passive state.

4. The method according to claim 1, wherein several pressure sensors are made available on the rotor blade, in particular along a longitudinal axis of the rotor blade.

5. The method according to claim 2, wherein several vortex generators are made available along a longitudinal axis of the rotor blade.

6. The method according to claim 1, wherein several pressure sensors are made available along a longitudinal axis of the rotor blade, and several vortex generators are made available along a longitudinal axis of the rotor blade, in particular wherein the vortex generators in areas defined along the longitudinal axis of the rotor blade can be individually controlled per area.

7. The method according to claim 1, wherein one or several desired values for at least one of the parameters selected from the group comprised of a high-speed number and a pitch angle are determined based on the detection of the characteristic aeroacoustic sound.

8. The method according to claim 7, wherein the one or several desired values are determined by means of a lookup table, in particular wherein the one or several desired values are ascertained through interpolation.

9. The method according to claim 1, wherein the at least one pressure sensor is a fiberoptic sensor.

10. A device for controlling a wind power plant with a rotor, comprising:
at least one pressure sensor secured to a rotor blade; and
an evaluation unit for detecting a characteristic aeroacoustic sound for at least one stall based on the sound emission; and controlling or regulating one or several components of the wind power plant based on the detection of the characteristic aeroacoustic sound.

11. The device according to claim 10, further comprising:
a computer program product which can be loaded into a memory of a digital computing device, and comprises software code sections with which the steps according to claim 1 can be implemented with the computer program product running on the computing device.

12. A wind power plant with the device according to claim 10.
